(19) United States
(12) Patent Application Publication
(10) Pub. No.: US 2011/0103742 A1
(43) Pub. Date: May 5, 2011

(54) PLASMON WAVEGUIDE AND OPTICAL ELEMENT USING THE SAME

(75) Inventors: Minoru Obara, Kanagawa (JP); Satoshi Omodani, Kanagawa (JP)

(73) Assignee: Keio University, Tokyo (JP)

(21) Appl. No.: 13/002,567

(22) PCT Filed: Jun. 22, 2009
(86) PCT No.: PCT/JP2009/061302

§ 371 Date: Jan. 4, 2011

(30) Foreign Application Priority Data
Jul. 8, 2008 (JP) 2008-177522

(51) Int. Cl. G02B 6/26; G02B 6/02

(52) U.S. Cl. 385/27

(57) ABSTRACT

Disclosed is a plasmon waveguide including cladding (2) consisted of metal, and a dielectric core (3) which is formed of a transparent material, surrounded by or sandwiched by the cladding (2), and has at least one cross-section having a thickness no more than the wavelength of the incident light. The plasmon waveguide is provided with: a incident-side plasmon waveguide (4) into which light (L) is incident; an emission-side plasmon waveguide (5) from which light (L) is emitted; a connection portion (6) connecting the incident-side plasmon waveguide (4) and emission-side plasmon waveguide (5); and a plasmon interference structure (7) which extends from the connection portion (6) in the direction intersecting the incident-side plasmon waveguide (4) or the emission-side plasmon waveguide (5), and has a terminal (7a) at which light (L) is reflected.

### TECHNICAL FIELD

The present invention relates to a plasmon waveguide for use in an optical circuit and an optical element using the same.

### BACKGROUND ART

Along with the advancement of highly-networked information society, an increase in the communication speed in an electronic circuit has been promoted. However, a transmission loss becomes large at high frequency, which makes communication difficult. Under such a circumstance, there is a strong demand for development of optical circuits capable of achieving high communication speed, and some of which have already been utilized.

In recent years, in order to respond to a demand for higher integration in the optical circuit, optical integration has been studied. However, in a conventional optical waveguide including a dielectric core and a cladding, the dimension of the waveguide cannot be reduced to equal or less than the wavelength used. That is, there is a lower limit on the dimension of the waveguide.

A surface plasmon waveguide that uses near-field light having no lower limit on its dimension in principle has gotten a lot of attention recently. The surface plasmon is near-field light propagating the metal surface, so that the dimension of the waveguide thereof can be down-sized to equal or less than the wavelength used.

In the case where an optical circuit is constructed using the plasmon waveguide, the plasmon waveguide is required to function as an optical function element, and a plasmon waveguide having high wavelength selectivity acts as the optical function element.

In fact, there has already been proposed a Bragg grating constituted using the plasmon waveguide (Non-Patent Document 1).

### CITATION LIST

### Patent Document

Patent Document 1: JP-A-2000-171650

Patent Document 2: JP-B-2599786

Patent Document 3: JP-A-2005-234245

Patent Document 4: JP-A-2007-303927

### Non-Patent Document

Non-Patent Document 1: “Surface Plasmon Bragg Gratings Formed in Metal-Insulator-Metal Waveguides”, Zhanghua Han, Erik Forsberg, Sailing He, IEEE PHOTONICS TECHNOLOGY LETTERS, VOL. 19, NO. 2, Jan. 15, 2007

Non-Patent Document 2: “Handbook of optical constants of solids”, Edward D. Palik, San Diego:Academic Press, 1985

Non-Patent Document 3: Eyal Feigenbaum and Meir Orenstein, Optics Express, 15, 17948 (2007)

### DISCLOSURE OF THE INVENTION

### Problems to be Solved by the Invention

However, as illustrated in FIG. 22, a wavelength filter using the surface plasmon Bragg grating has a structure in which the width of a dielectric core is made to change periodically to change the effective refractive index of the plasmon waveguide, and the larger the number of periods, the higher the wavelength filtering performance becomes. Therefore, in order to obtain sufficient performance as a wavelength filter, the number of wavelength periods needs to be increased to some extent, which poses a problem that the element length in the incident-light traveling direction is increased.

These microstructures are generally produced by a thin-film process. In the case of a surface plasmon Bragg grating wavelength filter having a configuration in which light travels in the film plane direction and having a series of periodic structures, it is possible to obtain the microstructure with less number of times of film formation and exposure processes. However, in the case of a surface plasmon Bragg grating having a configuration in which light travels in the perpendicular direction to the film plane direction, it would appear that the film formation and exposure processes need to be repeated for each period, increasing the number of processes, which may result in difficulty in packaging.

The present invention has been made to solve the above problems, and an object thereof is to provide a plasmon waveguide having a short element length in the incident-light traveling direction, a simple structure, and high wavelength selectivity and an optical element using the plasmon waveguide.

### Means for Solving the Problems

To attain the above object, according to an aspect of the present invention, there is provided a plasmon waveguide constituted by including a cladding consisted of metal and a dielectric core which is surrounded or sandwiched by the cladding and has at least one cross-section having a thickness equal to or less than the wavelength of the incident light, characterized by including: an incident-side plasmon waveguide into which light is incident; an emission-side plasmon waveguide from which the light is emitted; a connection portion which connects the incident-side plasmon waveguide and the emission-side plasmon waveguide; and a plasmon interference structure which extends from the connection portion in the direction intersecting the incident-side plasmon waveguide or the emission-side plasmon waveguide and has a terminal at which the light is reflected.

The plasmon waveguide has a plurality of the plasmon interference structures.

The incident-side plasmon waveguide and the emission-side plasmon waveguide extend in different directions.

The plasmon waveguide has a plurality of the incident-side plasmon waveguides.

The plasmon waveguide has a plurality of the emission-side plasmon waveguides.

The following conditional expression (1) is satisfied:

w×n<1.75λ (1)

where w is the length of the cross section of the dielectric core extending in the perpendicular direction to the thickness direction;

n is the refractive index of the dielectric core; and

λ is the wavelength of the light in a vacuum.

The following conditional expression (2) is satisfied:

t×n<0.5λ (2)

where t is the cross-sectional thickness of the dielectric core;

n is the refractive index of the dielectric core; and

λ is the wavelength of the light in a vacuum.

The length of the plasmon interference structure is determined such that light having a wavelength of 826.6 nm exhibits higher transmittance than light having a wavelength of 800 nm.

The cladding is formed of gold.

The dielectric core is formed of silicon oxide.

According to another aspect of the present invention, there is provided an optical element constituted by using the plasmon waveguide according to the present invention.

### Advantages of the Invention

According to the present invention, there can be provided a plasmon waveguide having a short element length in the incident-light traveling direction and a simple structure, and having high wavelength selectivity. Further, it is possible to increase the transmittance with a bent waveguide. Further, it is possible to make the plasmon waveguide function as an optical demultiplexer or multiplexer having high wavelength selectivity.

### BRIEF DESCRIPTION OF THE DRAWINGS

FIG. 1 is a perspective view of a plasmon waveguide according to a first embodiment.

FIG. 2 is a cross-sectional view of the plasmon waveguide of the first embodiment.

FIGS. 3(a) to 3(c) are views each illustrating the shapes of a cladding 2 and a dielectric core 3,

FIG. 4 is a view illustrating the transmittance observed when the length d of each of first plasmon interference structure 71 and second plasmon interference structure 72 of the first embodiment is changed.

FIGS. 5(a) and 5(b) are views each illustrating the propagation state of light L observed when the length d of each of first plasmon interference structure 71 and second plasmon interference structure 72 of the first embodiment are changed.

FIG. 6 is a view illustrating the transmittance relative to the wavelength observed when the length of each of first plasmon interference structure 71 and second plasmon interference structure 72 is fixed to 2720 nm.

FIG. 7 is a perspective view of a plasmon waveguide according to a second embodiment.

FIG. 8 is a cross-sectional view of the plasmon waveguide according to the second embodiment.

FIG. 9 is a view illustrating the transmittance observed when the length d of each of first plasmon interference structure 71 and second plasmon interference structure 72 of the second embodiment is changed.

FIGS. 10(a) and 10(b) are views each illustrating the propagation state of the light L observed when the length d of each of first plasmon interference structure 71 and second plasmon interference structure 72 of the second embodiment are changed.

FIG. 11 is a view illustrating the transmittance with respect to the wavelength observed when the length of each of first plasmon interference structure 71 and second plasmon interference structure 72 is fixed to 2660 nm.

FIGS. 12(a) and 12(b) are views each illustrating the transmittance observed when the width w of the dielectric core 3 of the second embodiment is changed.

FIG. 13 is a perspective view of the plasmon waveguide according to the third embodiment.

FIG. 14 is a cross-sectional view of the plasmon waveguide according to the third embodiment.

FIG. 15 is a view illustrating the transmittance with respect to the wavelength observed when the length of the first plasmon interference structure 71 is fixed to 1130 nm, and length of each of the second plasmon interference structure 72 and third plasmon interference structure 73 is fixed to 2660 nm.

FIGS. 16(a) to 16(c) are views each illustrating the propagation state of light observed when the wavelengths are set to 830 nm, 850 nm, and 870 nm.

FIG. 17 is a view illustrating a plasmon waveguide of Example 2 of the third embodiment.

FIG. 18 is a view illustrating a plasmon waveguide according to a fourth embodiment.

FIG. 19 is a view illustrating an application of the plasmon waveguide.

FIG. 20 is a view illustrating an application of the plasmon waveguide.

FIG. 21 is a view illustrating an application of the plasmon waveguide.

FIG. 22 is a view illustrating a conventional technique.

### BEST MODE FOR CARRYING OUT THE INVENTION

Embodiments of the present invention will be described with reference to the accompanying drawings.

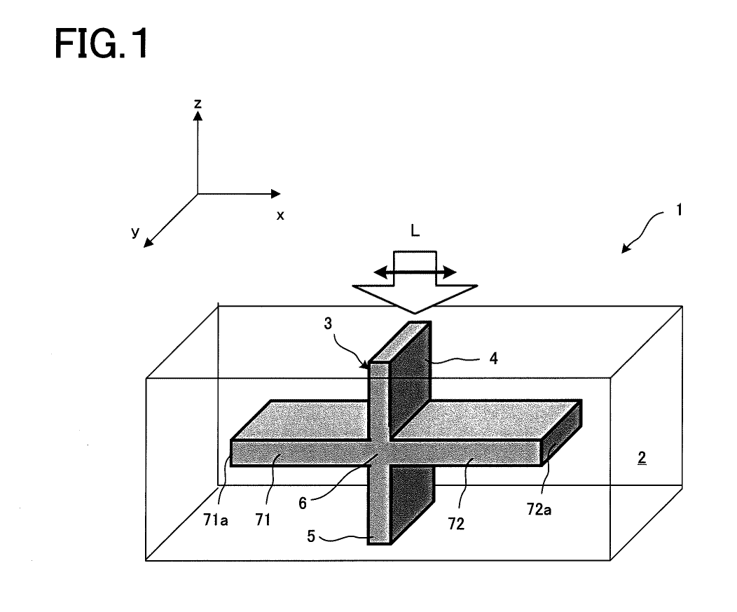

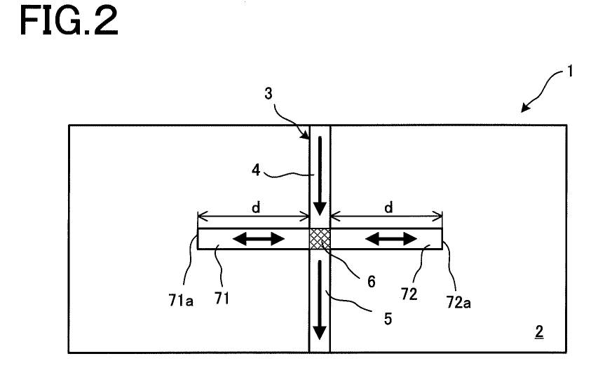

A first embodiment of a plasmon waveguide 1 will be described. FIG. 1 is a perspective view of a plasmon waveguide according to the first embodiment, and FIG. 2 is a cross-sectional view of the plasmon waveguide of the first embodiment. In FIGS. 1 and 2, reference numeral 1 denotes a plasmon waveguide, 2 denotes a cladding, 3 denotes a dielectric core, 4 denotes an incident-side plasmon waveguide, 5 denotes an emission-side plasmon waveguide, 6 denotes a connection portion, 7 denotes a plasmon interference structure, 71 denotes a first plasmon interference structure, 72 denotes a second plasmon interference structure, and L denotes light.

The plasmon waveguide 1 includes a cladding 2 made of metal and a dielectric core 3 and provided with an incident-side plasmon waveguide 4, an emission-side plasmon waveguide 5, a connection portion 6 connecting the incident-side plasmon waveguide 4 and the emission-side plasmon waveguide 5, and a plasmon interference structure 7 protruding from the connection portion 6 in the direction intersecting the incident-side plasmon waveguide 4 and emission-side plasmon waveguide 5.

The cladding 2 is formed of a plasmon active medium having a negative real part of complex dielectric constant. As the plasmon active medium, metal having high conductivity, such as gold, silver, copper, or aluminum is mainly used. In the present embodiment, gold is used as the plasmon active medium of the cladding 2.

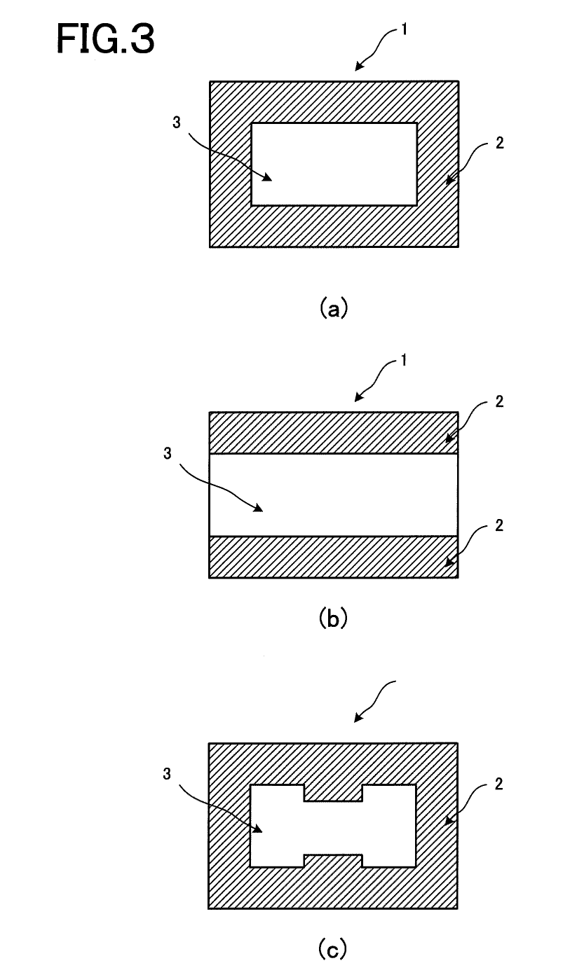

The dielectric core 3 is formed of a transparent dielectric body such as silicon oxide. The dielectric core 3 is surrounded by the metal cladding 2 as illustrated in FIG. 3(a) or sandwiched by the same as illustrated in FIG. 3(b) and has a cross section in which the thickness of at least one portion is not more than the wavelength of the light L as illustrated in FIG. 3(c). The dielectric core 3 is formed of a transparent material that transmits the light L. Examples of the transparent material include SiO₂ (silicon oxide), Al₂O₃, SiN, Ta₂O₅, SiON, Si, AlN, CaF₂, and oxide system glass.

The incident-side plasmon waveguide 4 is disposed on the incident side of the light L with respect to the connection portion 6, to which polarized light L is incident. The emission-side plasmon waveguide 5 is disposed on the emission side of the light L with respect to the connection portion 6, from which the light L is emitted. The connection portion 6 connects the incident-side plasmon waveguide 4 and emission-side plasmon waveguide 5. In the first embodiment, the light traveling direction in the incident-side plasmon waveguide 4 and that in the emission-side plasmon waveguide 5 are the same.

The plasmon interference structure 7 extends from the connection portion 6 in the direction intersecting the incident-side plasmon waveguide 4 or emission-side plasmon waveguide 5 and has a termination 7a at which the light L is reflected.

The plasmon interference structure 7 of the first embodiment includes a first plasmon interference structure 71 and a second plasmon interference structure 72. The first plasmon interference structure 71 and second plasmon interference structure 72 protrude from the connection portion 6 in the direction intersecting the incident-side plasmon waveguide 4 and emission-side plasmon waveguide 5, respectively. Further, the first plasmon interference structure 71 and second plasmon interference structure 72 each have a finite length in the plane direction, and a first terminal 71a and a second terminal 72a thereof are each shielded by a material or structure having high light reflectivity. The material having high light reflectivity is preferably the same as the material of the cladding 2 of the plasmon waveguide 1.

The light L has a wavelength in the range from ultraviolet to infrared and may have polarization components in all directions. Actually, polarization components in x-direction of the incident-side plasmon waveguide 4 propagate well, while the other polarization components significantly attenuate.

In the plasmon waveguide 1 of the first embodiment having such a configuration, the light L which is near-field light based on the surface plasmon enters the incident-side plasmon waveguide 4. Then, the light L propagates to the connection portion 6 and is branched to the first plasmon interference structure 71, second plasmon interference structure 72, and emission-side plasmon waveguide 5. The light L reflected at the finite first terminal 71a of the first plasmon interference structure 71 and light L reflected at the finite second terminal 72a of the second plasmon interference structure 72 reach once again the connection portion 6. At the connection portion 6, the light L from the incident-side plasmon waveguide 4 and the lights L reflected at the first terminal 71a of the first plasmon interference structure 71 and second terminal 72a of the second plasmon interference structure 72 interfere with one another. The light L resulting from the interference is emitted from the emission-side plasmon waveguide 5.

That is, the interference state of the light L at the connection portion 6 changes depending on the size or shape of each of the first plasmon interference structure 71 and second plasmon interference structure 72 to thereby change the transmittance and intensity of the light L to be emitted from the emission-side plasmon waveguide 5.

The dielectric core 3 is formed using silicon oxide and has a refractive index of 1.45. The incident-side plasmon waveguide 4 and emission-side plasmon waveguide 5 each have a thickness of 200 nm (x-direction) and a width of 600 nm (y-direction). The first plasmon interference structure 71 and second plasmon interference structure 72 each have a thickness of 200 nm (z-direction) and a width of 600 nm (y-direction).

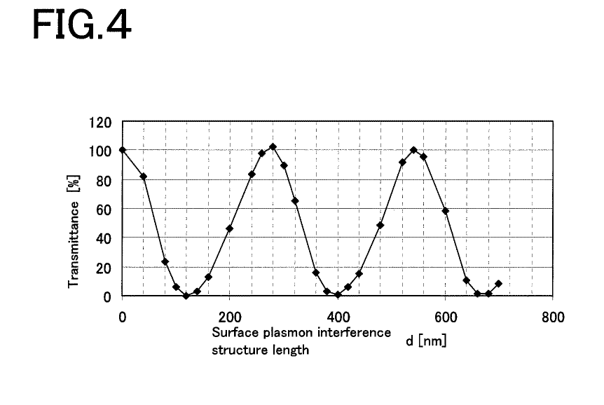

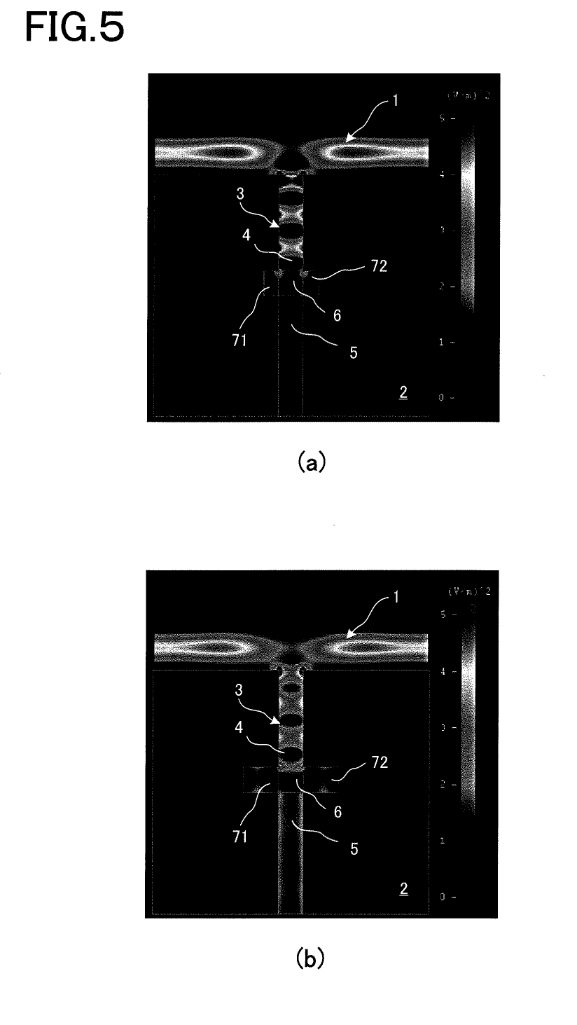

FIG. 4 illustrates the transmittance observed when the length d of each of the first plasmon interference structure 71 and second plasmon interference structures 72 of the first embodiment is changed. FIGS. 5(a) and 5(b) each illustrate the propagation state of the light L observed when the length d of each of the first plasmon interference structure 71 and second plasmon interference structure 72 of the first embodiment are changed.

The length d of the plasmon interference structure 7 refers to the distance from the boundary between the connection portion 6 and plasmon interference structure 7 to the terminal 7a of the plasmon interference structure 7. The transmittance is calculated by an electromagnetic field simulation as the ratio of the flow rate of energy passing through the emission-side plasmon waveguide 5 during the time period during which the electromagnetic field distribution in the present structure reaches a steady state as a result of continuous light irradiation onto the present structure in the case where the flow rate of energy passing through the emission-side plasmon waveguide 5 at that time period in the case where the first plasmon interference structure 71 and second plasmon interference structure 72 are not provided is set as 100%. The energy flow rate refers to a value obtained by surface integrating a Poynting vector in the light traveling direction with respect to the cross section of the emission-side plasmon waveguide 5. In this example, the emission-side plasmon waveguide 5 does not have a light emission surface but has an absorbing boundary A in the middle of the waveguide. The wavelength of the light L is 826.6 nm (1.5 eV).

For the electromagnetic field simulation, a simulation software for optical analysis simulation “Poynting for Optics®” made by Fujitsu Co. Ltd. was used. Also in the following embodiments, this simulation software for optical analysis is used for the electromagnetic field simulation.

In order to perform the electromagnetic field simulation more accurately, the actual measurement value of the refractive index of gold at a wavelength of 826.6 nm, which is described in Non-Patent Document 2, was applied to calculation, and light having a wavelength at which this refractive index is obtained was used as incident light. In calculating the transmission spectrum of each optical element using the electromagnetic field simulation, a refractive index at another wavelength was calculated based on the refractive index of gold at a wavelength of 826.6 nm, which is described in Non-Patent Document 2, in consideration of the wavelength dispersion.

A case where the length d of each of the first plasmon interference structure 71 and second plasmon interference structure 72 is 0 nm means a structure in which the first plasmon interference structure 71 and second plasmon interference structure 72 are not provided. The transmittance at this time is defined as 100%.

When the length d of each of the first plasmon interference structure 71 and second plasmon interference structures 72 is 120 nm, the transmittance is as very low as 0.31%. As illustrated in FIG. 5(a), the energy flow rate passing through the emission-side plasmon waveguide 5 is very low.

When the length d of each of the first plasmon interference structure 71 and second plasmon interference structure 72 is 280 nm, the transmittance is as very high as 102.6%. As illustrated in FIG. 5(b), energy continues to be supplied even in the steady state, so that the energy flow rate passing through the emission-side plasmon waveguide 5 is very high and 331 times higher than that of the transmittance obtained when the length d of each of the first plasmon interference structure 71 and second plasmon interference structure 72 is 120 nm.

When the length of each of the first plasmon interference structure 71 and second plasmon interference structure 72 is further changed, the transmittance changes between high and low values periodically, so that the length of each of the first plasmon interference structure 71 and second plasmon interference structure 72 can be made larger than the length illustrated in FIG. 4. That is, the transmittance at a given wavelength depends largely on the dimension of each of the first plasmon interference structure 71 and second plasmon interference structure 72. A part of the light that is not transmitted goes back through the incident-side plasmon waveguide 4, so that it can be said that the present structure in the case where the transmittance at the emission-side plasmon waveguide 5 is low is a structure having high reflectivity.

The reason that the transmittance exceeds 100% when the length d of the plasmon interference structure is set to 280 nm and 540 nm may be that the resonance state of the light L is formed in the incident-side plasmon waveguide 4 to enhance the plasmon resonance at a fine opening as the entrance to the incident-side plasmon waveguide 4, resulting in an increase in the incident light quantity to the fine opening.

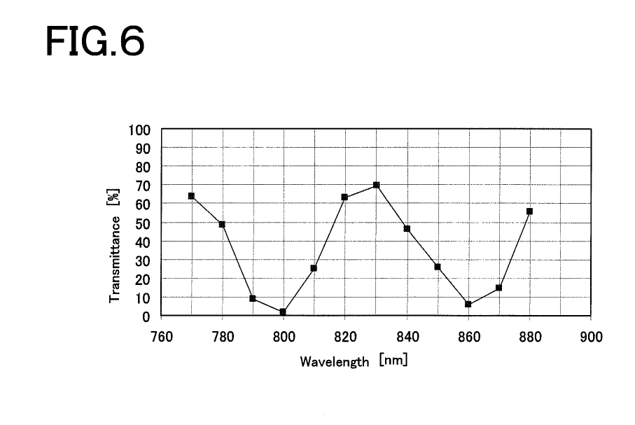

FIG. 6 is a view illustrating the transmittance observed when light having a wavelength of 770 nm to 880 nm is incident under the condition that the length d of each of the first plasmon interference structure 71 and second plasmon interference structure 72 of the first embodiment is fixed to 2720 nm.

In this example, the length d of 2720 nm is determined so as to exhibit transmission spectrum characteristics having a high transmittance near a wavelength of 826.6 nm and low transmittance near a wavelength of 800 nm. In FIG. 4 representing the dependency of the transmittance on the length d, the local maximum and local minimum values periodically appear with respect to the length d, so that a length d providing the local maximum value of the transmittance in the case where the length d of each of the first plasmon interference structure 71 and second plasmon interference structure 72 is set to a value larger than those set in FIG. 4 can be estimated. For example, when the graph of FIG. 4 is extended to the right, the point at which the length d=2720 nm indicates the tenth local maximum value (assuming that the local maximum value at the point at which d=280 nm is the first local maximum value). Further, the period of the transmittance is proportional to the wavelength in the plasmon waveguide. Thus, the dependency of the transmittance on the length d observed when light having a wavelength of 800 nm is incident can be estimated, so that the length d providing the local minimum value of the transmittance can also be estimated. Based on the above consideration, the length d is determined so as to exhibit transmission spectrum characteristics having a high transmittance near a wavelength of 826.6 nm and low transmittance near a wavelength of 800 nm.

The maximum transmittance of 69.7% is obtained at a wavelength of 830 nm. The transmittance becomes lower at wavelengths around 830 nm and decreases to 1.68% at a wavelength of 800 nm and to 6.01% at a wavelength of 860 nm. That is, the present structure has a wavelength dependency of the transmittance and can function as a wavelength filter. Thus, by adjusting the size of each of the first plasmon interference structure 71 and second plasmon interference structure 72, desired filter characteristics can be obtained. For example, when the length d of the plasmon interference structure 7 is increased, the transparent wavelength band at a given wavelength becomes narrow, while when the length d of the plasmon interference structure 7 is reduced, the transparent wavelength band at a given wavelength becomes broad. The dimensions (widths, lengths, etc.) of the first plasmon interference structure 71 and second plasmon interference structure 72 need not be equal but may differ from each other.

According to the first embodiment, it is possible to provide a plasmon waveguide having a short element length in the incident-light traveling direction, a simple structure, and high wavelength selectivity.

Next, a second embodiment of the plasmon waveguide 1 will be described. The second embodiment relates to a technique concerning a bent waveguide.

As a bent waveguide, a bent waveguide formed by using high-refractive-index silicon, a bent waveguide (patent Document 1) formed by a core layer side surface provided with a metal cladding layer, and the like have been studied, and high integration is intended to be achieved by downsizing of the bent part of an optical circuit.

It has been demonstrated that, in a conventional bent plasmon waveguide, in particular, in a plasmon waveguide in which a core formed of a transparent material is sandwiched by a metal cladding in the light polarization direction cross section, even if the plasmon waveguide is simply bent 90°, a bending light loss does not occur under the condition that the light polarization direction core width is sufficiently smaller than the wavelength. However, the smaller the core width becomes relative to the wavelength, the larger the light propagation loss at the straight-line portion of the plasmon waveguide, so that the entire loss becomes large, considering the light propagation in the plasmon waveguide before and after the 90° bent plasmon waveguide. As described above, there exits a trade-off problem between the bending light loss at the plasmon waveguide bent portion and light propagation loss in the plasmon waveguide before and after the plasmon waveguide bent portion.

Further, in a plasmon waveguide having curved portions, 90° bending in all directions is difficult in terms of a fabrication process. That is, when the bent plasmon waveguide is fabricated by a thin-film process, fabrication of the curved potion connecting a waveguide extending in the film plane direction and waveguide extending in the film normal direction is difficult. In order to realize an optical circuit using the plasmon waveguide, a structure in which 90° bending in all directions can be achieved with a simple process and small loss is required.

The second embodiment aims to provide a bent plasmon waveguide having a simple structure and small loss.

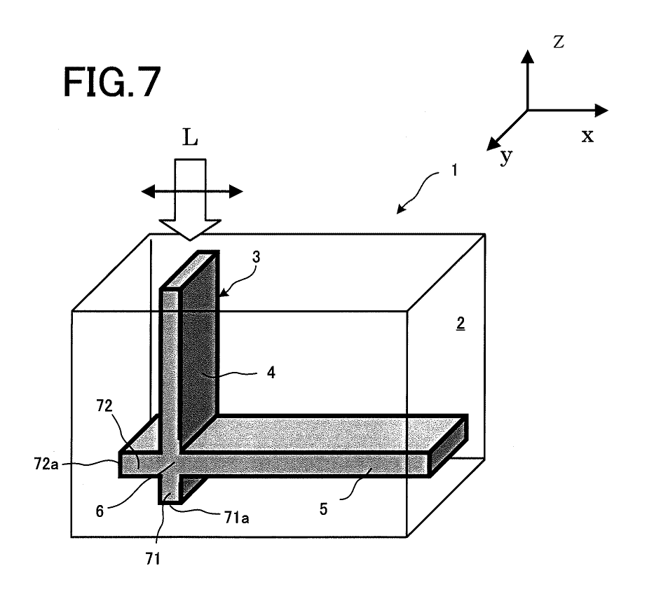

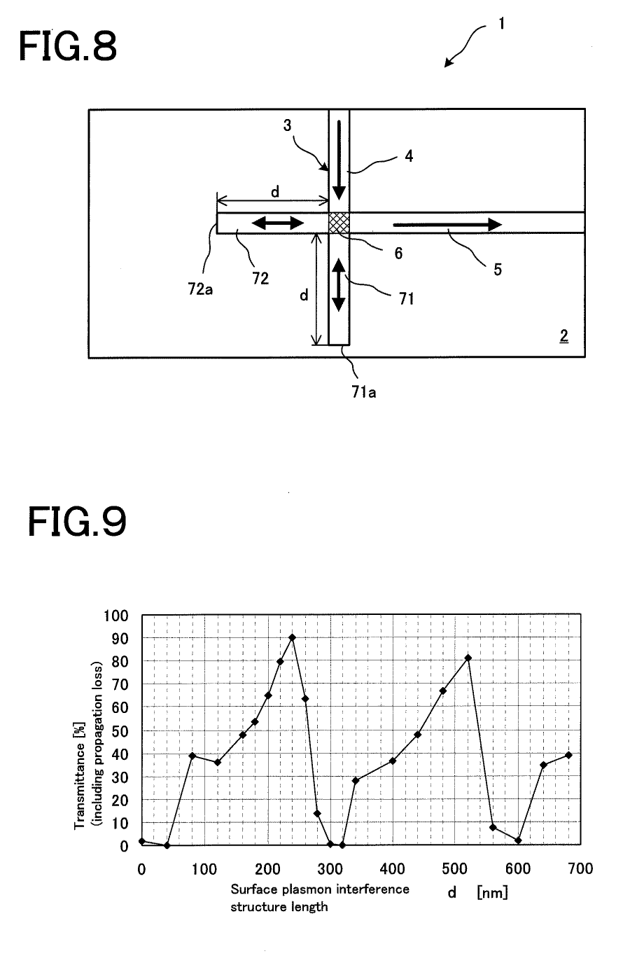

FIG. 7 is a perspective view of a plasmon waveguide according to the second embodiment, and FIG. 8 is a cross-sectional view of the plasmon waveguide according to the second embodiment.

The plasmon waveguide 1 according to the second embodiment includes a cladding 2 made of metal and a dielectric core 3 and provided with an incident-side plasmon waveguide 4, an emission-side plasmon waveguide 5 extending in a different direction from the incident-side plasmon waveguide 4, a connection portion 6 connecting the incident-side plasmon waveguide 4 and the emission-side plasmon waveguide 5, and a first plasmon interference structure 71 and a second plasmon interference structure 72 protruding from the connection portion 6 in the direction intersecting the emission-side plasmon waveguide 4 and incident-side plasmon waveguide 4, respectively, wherein the first plasmon interference structure 71 extends from the connection portion 6 along the extension of the incident-side plasmon waveguide 4 in the direction intersecting the emission-side plasmon waveguide 5, and second plasmon interference structure 72 extends from the connection portion 6 along the extension of the emission-side plasmon waveguide 5 in the direction intersecting the incident-side plasmon waveguide 4, thereby forming a bent structure.

In the plasmon waveguide 1 of the second embodiment having such a configuration, the light L which is near-field light based on the surface plasmon enters the incident-side plasmon waveguide 4. Then, the light L propagates to the connection portion 6 and is branched to the first plasmon interference structure 71, second plasmon interference structure 72, and emission-side plasmon waveguide 5. The light L reflected at a finite first terminal 71a of the first plasmon interference structure 71 and light L reflected at a finite second terminal 72a of the second plasmon interference structure 72 reach once again the connection portion 6. At the connection portion 6, the light L from the incident-side plasmon waveguide 4 and the lights L reflected at the first terminal 71a of the first plasmon interference structure 71 and second terminal 72a of the second plasmon interference structure 72 interfere with one another. The light L resulting from the interference is emitted from the emission-side plasmon waveguide 5.

That is, the interference state of the light L at the connection portion 6 changes depending on the size or shape of each of the first plasmon interference structure 71 and second plasmon interference structure 72 to thereby change the transmittance and intensity of the light L to be emitted from the emission-side plasmon waveguide 5.

The dielectric core 3 is formed using silicon oxide and has a refractive index of 1.45. The incident-side plasmon waveguide 4 has a thickness of 200 nm (x-direction) and a width of 600 nm (y-direction), and emission-side plasmon waveguide 5 has a thickness of 200 nm (z-direction) and a width of 600 nm (y-direction). The first plasmon interference structure 71 has a thickness of 200 nm (x-direction) and a width of 600 nm (y-direction), and second plasmon interference structure 72 has a thickness of 200 nm (z-direction) and a width of 600 nm (y-direction).

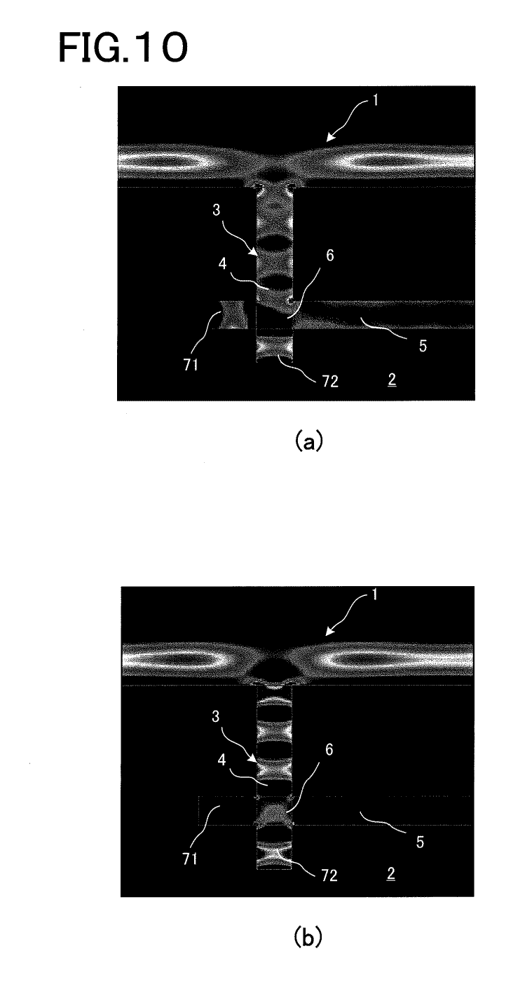

FIG. 9 illustrates the transmittance observed when the length d of each of the first plasmon interference structure 71 and second plasmon interference structure 72 of the second embodiment is changed. FIGS. 10(a) and 10(b) each illustrate the propagation state of the light L observed when the length d of each of the first plasmon interference structure 71 and second plasmon interference structure 72 of the second embodiment are changed.

The length d of the plasmon interference structure 7 refers to the distance from the boundary between the connection portion 6 and the plasmon interference structure 7 to the terminal 7a of the plasmon interference structure 7. The transmittance in the present embodiment can be translated as bending efficiency and is calculated by an electromagnetic field simulation as the ratio of the flow rate of energy at a position immediately after the energy passes through the connection portion during the time period during which the electromagnetic field distribution in the present structure reaches a steady state in the case where the flow rate of energy passing from the incident-side plasmon waveguide 4 to a position immediately before the connection portion 6 is set as 100%.

The energy flow rate refers to a value obtained by surface integrating a Poynting vector in the light traveling direction with respect to the cross section of the emission-side plasmon waveguide 5. In this example, the emission-side plasmon waveguide 5 does not have a light emission surface but has an absorbing boundary A in the middle of the waveguide. The wavelength of the light L is 826.6 nm (1.5 eV).

A case where the length d of each of the first plasmon interference structure 71 and second plasmon interference structure 72 is 0 nm means a structure in which the first plasmon interference structure 71 and second plasmon interference structure 72 are not provided. The transmittance at this time is as low as 2.04%.

When the length d of each of the first plasmon interference structure 71 and second plasmon interference structures 72 is 240nm, the transmittance is as high as 90.0% and 44.1 times higher than that of the transmittance obtained when the length d of each of the first plasmon interference structure 71 and second plasmon interference structures 72 is 0 nm. As illustrated in FIG. 10(a), the flow rate of energy passing through the emission-side plasmon waveguide 5 is very high.

When the length d of each of the first plasmon interference structure 71 and second plasmon interference structure 72 is 320 nm, the transmittance is as low as 0.04%. As illustrated in FIG. 10(b), the flow rate of energy passing through the emission-side plasmon waveguide 5 is very low and 2250 times lower than that of the transmittance obtained when the length d of each of the first plasmon interference structure 71 and second plasmon interference structure 72 is 240 nm.

When the length of each of the first plasmon interference structure 71 and second plasmon interference structure 72 is further changed, the transmittance changes between high and low values periodically, so that the length of each of the first plasmon interference structure 71 and second plasmon interference structure 72 can be made larger than the length d illustrated in FIG. 9. That is, the transmittance at a given wavelength depends largely on the dimension of each of the first plasmon interference structure 71 and second plasmon interference structure 72. A part of the light that is not transmitted goes back through the incident-side plasmon waveguide 4, so that it can be said that the present structure in the case where the transmittance at the emission-side plasmon waveguide 5 is low is a structure having high reflectivity.

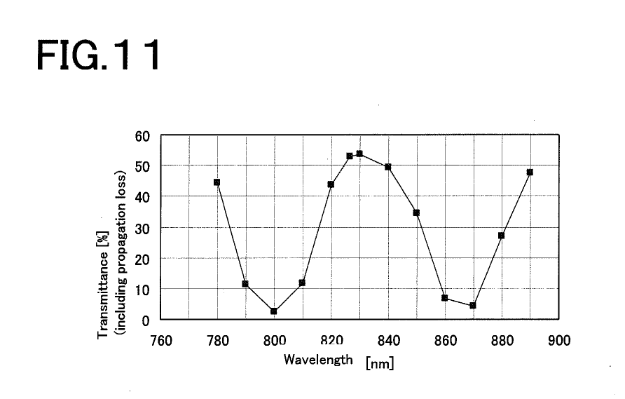

FIG. 11 is a view illustrating the transmittance observed when light having a wavelength of 780 nm to 890 nm is incident under the condition that the length d of each of the first plasmon interference structure 71 and second plasmon interference structure 72 of the second embodiment is fixed to 2660 nm.

In this example, the length d of 2660 nm is determined so as to exhibit transmission spectrum characteristics having a high transmittance near a wavelength of 826.6 nm and low transmittance near a wavelength of 800 nm. In FIG. 9 representing the dependency of the transmittance on the length d, the local maximum and local minimum values of the transmittance periodically appear with respect to the length d, so that a length d providing the local maximum value of the transmittance in the case where the length d of each of the first plasmon interference structure 71 and second plasmon interference structure 72 is set to a value larger than those set in FIG. 9 can be estimated. For example, when the graph of FIG. 9 is extended to the right, the point at which the length d=2660 nm indicates the tenth local maximum value (assuming that the local maximum value at the point at which d=240 nm is the first local maximum value). Further, the period of the transmittance is proportional to the wavelength in the plasmon waveguide. Thus, the dependency of the transmittance on the length d observed when light having a wavelength of 800 nm is incident can be estimated, so that the length d providing the local minimum value of the transmittance can also be estimated. Based on the above consideration, the length d is determined so as to exhibit transmission spectrum characteristics having a high transmittance near a wavelength of 826.6 nm and low transmittance near a wavelength of 800 nm.

The maximum transmittance of 53.7% is obtained at a wavelength of 830 nm. The transmittance becomes lower at wavelengths around 830 nm and decreases to 2.6% at a wavelength of 800 nm and to 4.1% at a wavelength of 870 nm. That is, the present structure has a wavelength dependency of the transmittance and can function as a wavelength filter. Thus, by adjusting the size of each of the first plasmon interference structure 71 and second plasmon interference structure 72, desired filter characteristics can be obtained. For example, when the length d of the plasmon interference structure 7 is increased, the transparent wavelength band at a given wavelength becomes narrow, while when the length d of the plasmon interference structure 7 is reduced, the transparent wavelength band at a given wavelength becomes broad. The dimensions (widths, lengths, etc.) of the first plasmon interference structure 71 and second plasmon interference structure 72 need not be equal but may differ from each other.

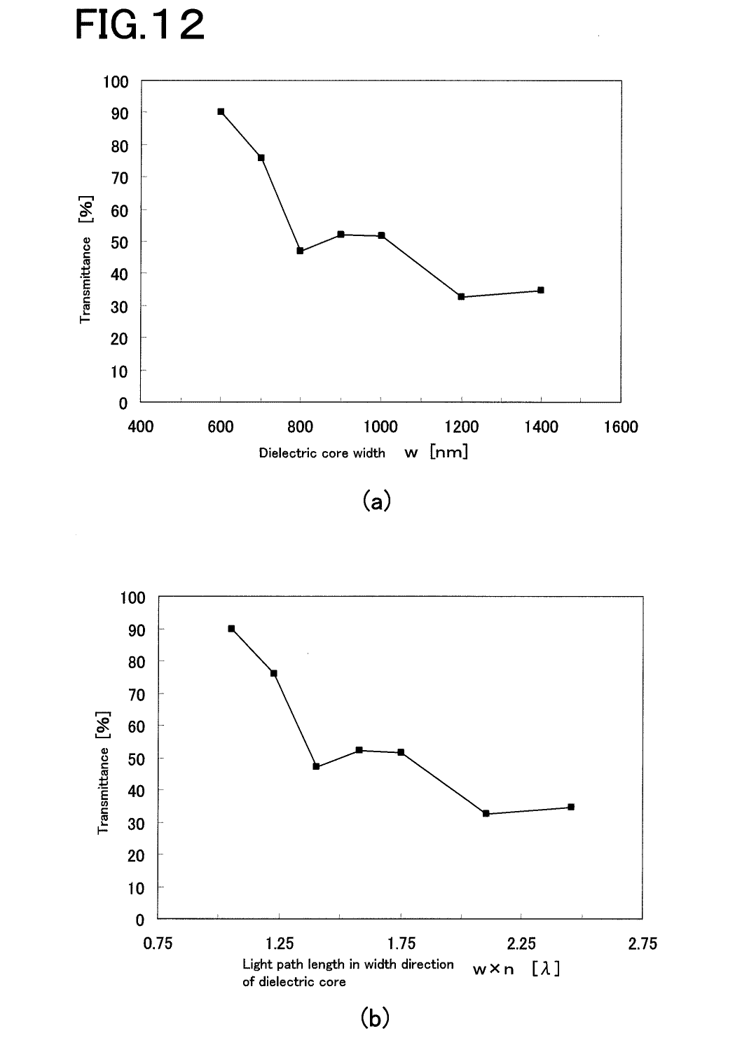

FIGS. 12(a) and 12(b) are views each illustrating the transmittance observed when the width w of the dielectric core 3 of the second embodiment is changed. FIG. 12(a) is a graph in which the width w is expressed in the unit of nm, and FIG. 12(b) is a graph in which the light path length in the width direction of the dielectric core 3 is normalized by λ.

The light path length in the width direction of the dielectric core 3 refers to a value obtained by multiplying the width of the dielectric core 3 by the refractive index n of the dielectric core 3. Since the transmittance n becomes significantly low when the light path length in the width direction of the dielectric core 3 is larger than 1.75λ, it can be determined that deterioration in the performance of the present embodiment occurs. That is, when the light path length in the width direction of the dielectric core 3 is larger than 1.75λ, high order propagation mode in the width direction (y-direction) of the dielectric core 3 becomes dominant to make constructive interference of the emission light at the connection portion insufficient. Thus, a condition that the basic propagation mode in the width direction of the dielectric core 3 becomes dominant is desired.

For example, the following conditional expression (1) is preferably satisfied:

w×n<1.75λ (1)

where w is the length of the cross section of the dielectric core extending in the perpendicular direction to the thickness direction;

n is the refractive index of the dielectric core; and

λ is the wavelength of the light in a vacuum.

According to the second embodiment, it is possible to provide a plasmon waveguide having a short element length in the incident-light traveling direction and a simple structure, capable of increasing the transmittance with a bent waveguide, and having high wavelength selectivity.

Next, Example 1 of a third embodiment of the plasmon waveguide 1 will be described. The plasmon waveguide 1 of the third embodiment relates to a technique concerning an optical wavelength demultiplexer.

In recent years, a technique of an optical wavelength multiplexer/demultiplexer, which is an optical communication circuit component for realizing wavelength multiplexing capable of large-capacity transmission, has been established. As described in Patent Document 2, in particular, as to an arrayed waveguide grating serving as an element having a wavelength filtering performance, various characteristic improvements or function pursuits have been made since the development of the basic functional devices thereof. For example, as described in Patent Document 3, a technique for reducing the area of the arrayed waveguide has been developed.

As described in Patent Document 3, downsizing of the wavelength multiplexer/demultiplexer has been made. However, in such a wavelength multiplexer/demultiplexer using an optical waveguide that includes a dielectric cladding and a dielectric core, the width of its optical waveguide including the cladding cannot be made equal to or less than the wavelength, so that there is a limit on an increase in integration (reduction in size).

As a technical field in which a fine optical element for achieving high integration is supposed to be required, an optical interconnect technology in which high-speed optical communication is performed in a CPU chip can be exemplified. Utilizing this technology, there emerges an idea of close-range multiple-wavelength high-speed optical communication. In this technical field, it is supposed that an arrayed waveguide grating is used mainly and that one high sensitivity/high-speed response silicon nano-photodiode is disposed for each wavelength through the arrayed waveguide grating, that is, a plurality of silicon nano-photodiodes are disposed. Thus, downsizing of each element becomes a major issue.

An optical waveguide including a dielectric core and a dielectric cladding has a limit on the waveguide dimension or bending radius as described above, while a plasmon waveguide including a dielectric core and a metal cladding contributes elimination of a limit on the waveguide dimension or bending radius. Thus, in constructing an optical circuit in a highly integrated manner, the plasmon waveguide including a dielectric core and a metal cladding is preferably used. Therefore, an optical wavelength multiplexer/demultiplexer that can be used on the plasmon waveguide is required.

The third embodiment aims to provide an optical wavelength multiplexer/demultiplexer that can be used in the plasmon waveguide.

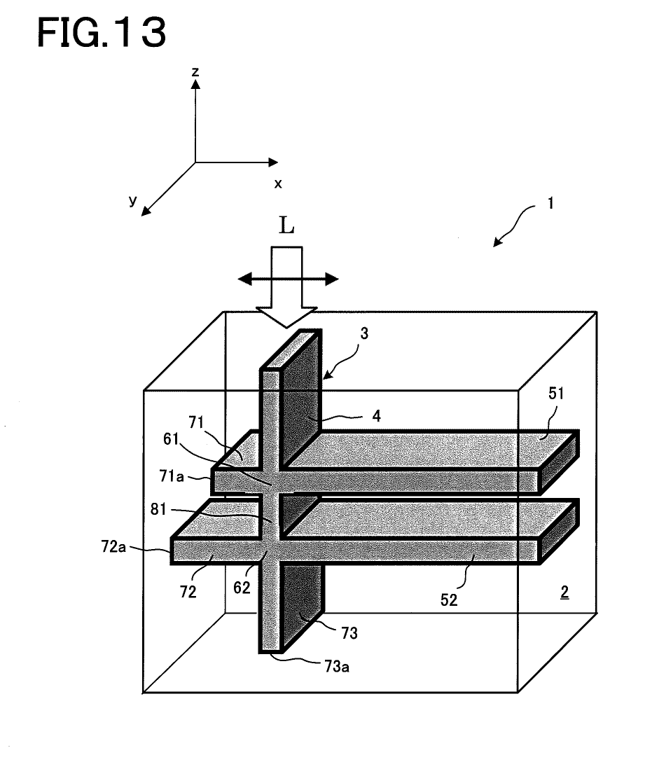

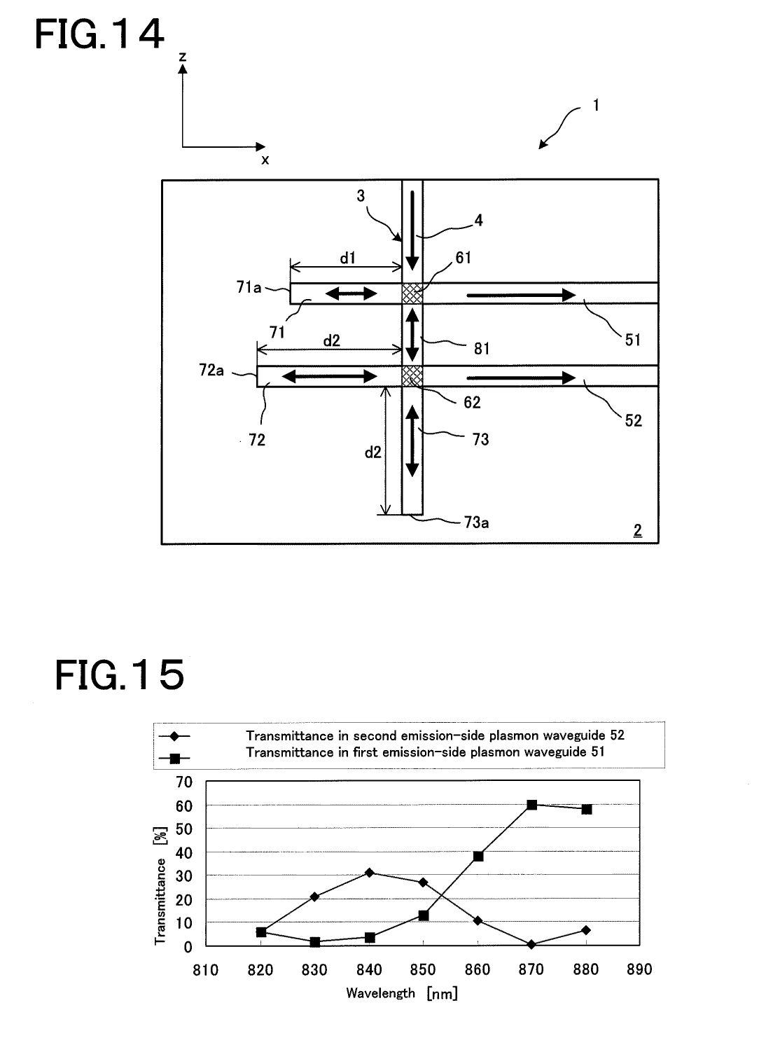

FIG. 13 is a perspective view of the plasmon waveguide according to the third embodiment, and FIG. 14 is a cross-sectional view of the plasmon waveguide according to the third embodiment.

The plasmon waveguide 1 according to the third embodiment includes a cladding 2 made of metal and a dielectric core 3 and is provided with an incident-side plasmon waveguide 4, a first emission-side plasmon waveguide 51, a second emission-side plasmon waveguide 52, a first connection portion 61 connecting the incident-side plasmon waveguide 4 and first emission-side plasmon waveguide 51, a second connection portion 62 connecting the incident-side plasmon waveguide 4 and second emission-side plasmon waveguide 52, a first plasmon interference structure 71 protruding from the first connection portion 61 in the direction intersecting the incident-side plasmon waveguide 4, a second plasmon interference structure 72 and a third plasmon interference structure 73 protruding from the second connection portion 62 in the direction intersecting the incident-side plasmon waveguide 4 and second emission-side plasmon waveguide 52, respectively, and a first joint 81 connecting the first connection portion 61 and second connection portion 62, wherein the first plasmon interference structure 71 extends from the first connection portion 61 along the extension of the first emission-side plasmon waveguide 51, the second plasmon interference structure 72 extends from the second connection portion 62 along the extension of the second emission-side plasmon waveguide 52, and the third plasmon interference structure 73 extends from the second connection portion 62 along the extension of the incident-side plasmon waveguide 4, thereby functioning as an optical wavelength demultiplexer.

In the plasmon waveguide 1 of the third embodiment having such a configuration, the light L which is near-field light based on the surface plasmon enters the incident-side plasmon waveguide 4. Then, the light L propagates to the first connection portion 61 and is branched to the first plasmon interference structure 71, first joint 81, and first emission-side plasmon waveguide 51.

The light L reflected at a finite first terminal 71a of the first plasmon interference structure 71 reaches once again the first connection portion 61.

The light L propagating through the first joint 81 reaches the second connection portion 62 and is branched to the second plasmon interference structure 72, third plasmon interference structure 73, and second emission-side plasmon waveguide 52.

The light L reflected at a finite second terminal 72a of the second plasmon interference structure 72 and light L reflected at a finite third terminal 73a of the third plasmon interference structure 73 reach once again the second connection portion 62. The light L that has reached once again the second connection portion 62 is branched to the first joint 81 and second emission-side plasmon waveguide 52.

Thus, at the first connection portion 61, the light L from the incident-side plasmon waveguide 4, light L reflected at the first terminal 71a of the first plasmon interference structure 71, and light L including the light L reflected at the finite second terminal 72a of the second plasmon interference structure 72 and light L reflected at the finite third terminal 73a of the third plasmon interference structure 73 that has reached once again the first connection portion 61 after propagating through the first joint 81 interfere with one another. The light L resulting from the interference is bent and then emitted from the first emission-side plasmon waveguide 51.

Further, at the second connection portion 62, the light L that has propagated through the first joint 81, light L reflected at the finite second terminal 72a of the second plasmon interference structure 72, and light L reflected at the finite third terminal 73a of the third plasmon interference structure 73 interfere with one another. The light L resulting from the interference is bent and then emitted from the second emission-side plasmon waveguide 52.

That is, the interference state of the light L at the first connection portion 61 and second connection portion 62 changes depending on the size or shape of each of the first, second, and third plasmon interference structures 71, 72, and 73 to thereby change the transmittance and intensity of the light L to be emitted from the first emission-side plasmon waveguide 51 and second emission-side plasmon waveguide 52.

The dielectric core 3 is formed using silicon oxide and has a refractive index of 1.45. The incident-side plasmon waveguide 4 has a thickness of 200 nm (x-direction) and a width of 600 nm (y-direction), and first emission-side plasmon waveguide 51 and second emission-side plasmon waveguide 52 each have a thickness of 200 nm (z-direction) and a width of 600 nm (y-direction). The first plasmon interference structure 71 has a thickness of 200 nm (z-direction) and a width of 600 nm (y-direction), second plasmon interference structure 72 has a thickness of 200 nm (z-direction) and a width of 600 nm (y-direction), and third plasmon interference structure 73 has a thickness of 200 nm (x-direction) and a width of 600 nm (y-direction).

FIG. 15 is a view illustrating the transmittance observed when light having a wavelength of 820 nm to 880 nm is incident under the condition that the length d1 of the first plasmon interference structure 71 of the third embodiment is fixed to 1130 nm, and length d2 of each of the second plasmon interference structure 72 and third plasmon interference structure 73 is fixed to 2660 nm.

The length d1 of the first plasmon interference structure 71 refers to the distance from the boundary between the first connection portion 61 and first plasmon interference structure 71 to the first terminal 71a of the first plasmon interference structure 71 (x-direction). The length d2 of the second plasmon interference structure 72 refers to the distance from the boundary between the second connection portion 62 and second plasmon interference structure 72 to the second terminal 72a of the second plasmon interference structure 72 (x-direction). The length d2 of the third plasmon interference structure 73 refers to the distance from the boundary between the second connection portion 62 and third plasmon interference structure 73 to the third terminal 73a of the third plasmon interference structure 73 (z-direction).

The transmittance in the present embodiment is calculated by an electromagnetic field simulation as the ratio of the flow rate of energy passing through the emission-side plasmon waveguide of the optical wavelength multiplexer/demultiplexer during the time period during which the electromagnetic field distribution in the present structure reaches a steady state in the case where the flow rate of energy passing from the incident-side plasmon waveguide 4 to a position immediately before the first connection portion 61 is set as 100%. The energy flow rate refers to a value obtained by surface integrating a Poynting vector in the light traveling direction with respect to the cross section of the emission-side plasmon waveguide 5.

When the wavelength is 830 nm, the transmittance of the second emission-side plasmon waveguide 52 is as high as 20.67%, and the transmittance of the first emission-side plasmon waveguide 51 is as low as 2.062%, and the ratio between them is 10.02, which is the maximum. When the wavelength is 870 nm, the transmittance of the first emission-side plasmon waveguide 51 is as high as 59.85%, the transmittance of the second emission-side plasmon waveguide 52 is as low as 0.340%, and the ratio between them is 176.2, which is the maximum.

That is, the wavelengths of the light transmitting through the first emission-side plasmon waveguide 51 and second emission-side plasmon waveguide 52 change depending on the size of the first plasmon interference structure 71, second plasmon interference structure 72, and third plasmon interference structure 73. Thus, by arranging the emission-side plasmon waveguide 5 provided with the plasmon interference structure 7 contributing to an increase in the transmittance at a given wavelength and arranging the emission-side plasmon waveguide 5 provided with the plasmon interference structure 7 contributing to a decrease in the transmittance at the same given wavelength, it is possible to guide more light to one emission-side plasmon waveguide 5 at the given wavelength. Further, existence of the wavelengths between which the magnitude relationship of the transmittance is largely reversed allows switching between emission destinations, i.e., the two emission-side plasmon waveguides 5 depending on the wavelength used. The magnitude in size of the plasmon interference structure provided to each connection portion may be adjusted by the wavelength dependency of the transmittance or extinction ratio calculated in each emission-side plasmon waveguide 5.

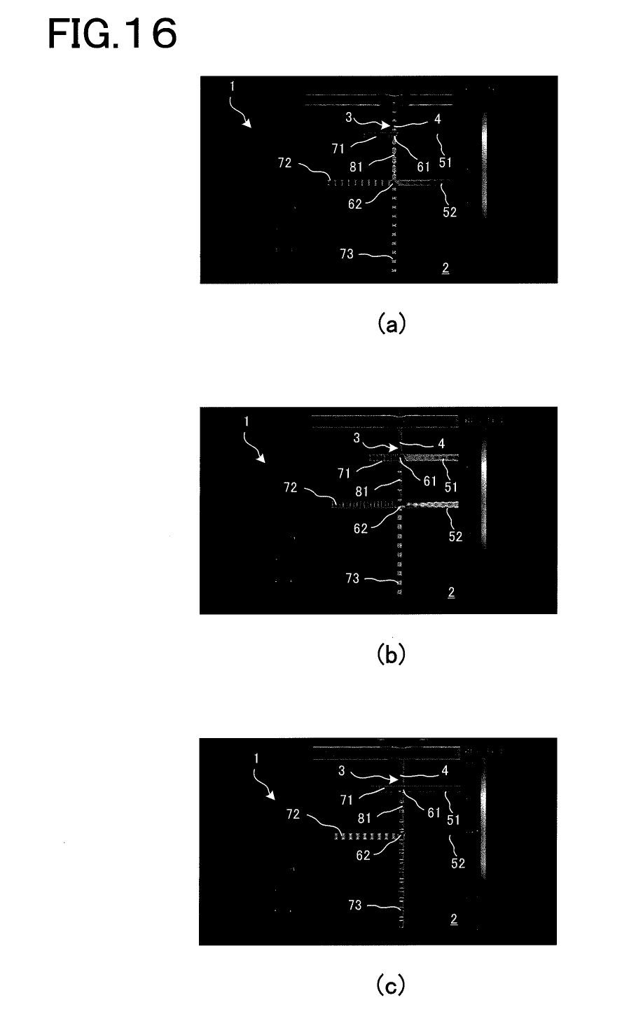

FIGS. 16(a) to 16(c) are views each illustrating the propagation state of the light observed when the wavelengths are set to 830 nm, 850 nm, and 870 nm. FIG. 16(a) illustrates a case of 830 nm, FIG. 16(b) a case of 850 nm, and FIG. 16(c) a case of 870 nm.

The first plasmon interference structure 71 having a length d1 of 1330 nm is designed so as to guide light having a wavelength around 870 nm to the first emission-side plasmon waveguide 51 with high efficiency and so as not to guide light having a wavelength around 830 nm to the first emission-side plasmon waveguide 51. The second plasmon interference structure 72 and third plasmon interference structure 73 each having a length d2 of 2660 nm are designed so as to guide light having a wavelength around 830 nm to the second emission-side plasmon waveguide 52 with high efficiency and so as not to guide light having a wavelength around 870 nm to the second emission-side plasmon waveguide 52.

The first joint 81 preferably has such a length as to form a resonant state that makes light to propagate well to the second emission-side plasmon waveguide when reflection occurs at the second plasmon interference structure 72 and third plasmon interference structure 73 to form a light resonance state and having wavelength dependency of a resonant state close to that of the first plasmon interference structure 71. In this example, the first joint 81 has a length m of 1220 nm.

According to the third embodiment, it is possible to provide a plasmon waveguide having a short element length in the incident-light traveling direction and a simple structure, capable of increasing the transmittance with a bent waveguide, having high wavelength selectivity, and having a function as an optical demultiplexer.

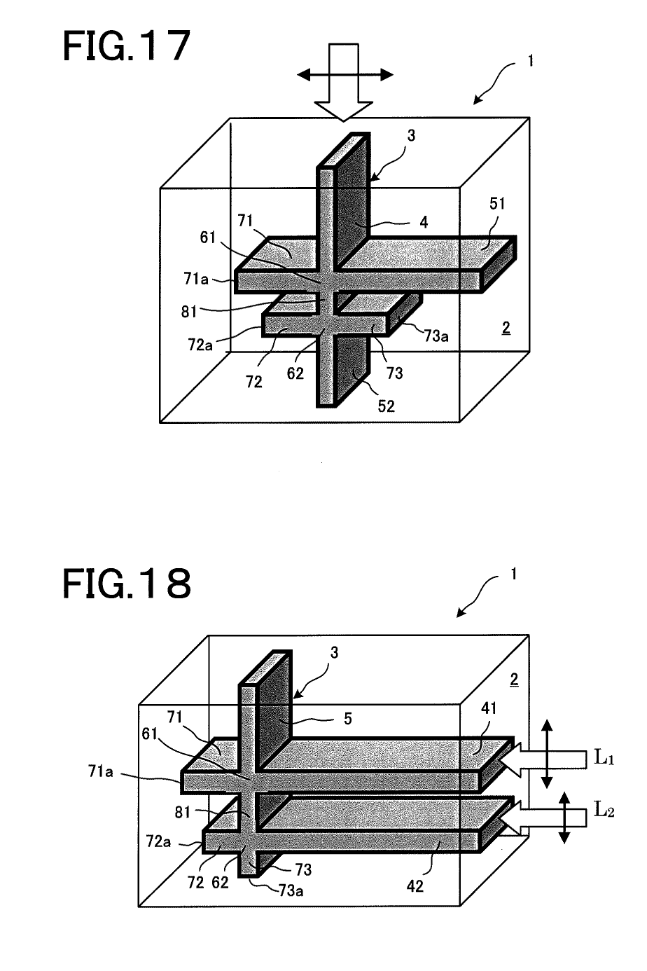

Next, a plasmon waveguide of Example 2 of the third embodiment will be described. FIG. 17 is a view illustrating a plasmon waveguide of Example 2 of the third embodiment. In this plasmon waveguide, the arrangement in which light from the single incident-side plasmon waveguide 4 is wavelength-demultiplexed to the first emission-side plasmon waveguide 51 and second emission-side plasmon waveguide 52 is modified. The materials and cross-sectional shapes of the incident-side plasmon waveguide 4, emission-side plasmon waveguide 5, connection portion 6, plasmon interference structure 7, and joint 8 are the same as those of Example 1. The light traveling direction of the first emission-side plasmon waveguide 51 of the emission-side plasmon waveguide 5 is the same as the light polarization direction of the incident-side plasmon waveguide 4, and light traveling direction of the second emission-side plasmon waveguide 52 of the emission-side plasmon waveguide 5 is the same as the light traveling direction of the incident-side plasmon waveguide 4.

The structure of Example 2 has an advantage that both the second plasmon interference structure 72 and third plasmon interference structure 73 can be made to extend in the light polarization direction of the incident-side plasmon waveguide 4. In the case of above Example 1, the third plasmon interference structure 73 extends in the same direction as the light traveling direction of the incident-side plasmon waveguide 4, so that a certain length is required in the light traveling direction of the incident-side plasmon waveguide 4, which may fail to conform to the thin-film process. That is, in the case where the plasmon interference structure 7 needs to have a sufficient length in order to obtain desired wavelength characteristics and where the direction in which the sufficient length is required is perpendicular to the film plane in the thin-film process, it is difficult to stably form the cross-sectional shape of the plasmon interference structure 7 in the perpendicular direction to the film plane.

On the other hand, both the second plasmon interference structure 72 and third plasmon interference structure 73 in Example 2 extend in the perpendicular direction of the incident-side plasmon waveguide 4, so that only a certain thickness is required in the same direction as the incident-side plasmon waveguide 4 in order to obtain any wavelength characteristics, which is suitable to the thin-film process.

By connecting a plurality of optical wavelength multiplexer/demultiplexers having the above structure, which means that the emission-side plasmon waveguide 5 is connected to the incident-side plasmon waveguide 4 of another optical wavelength multiplexer/demultiplexer having the structure of Example 2, the number of the emission-side plasmon waveguides 5 can arbitrarily be increased.

Further, by making the plasmon interference structures 7 the same in shape in this structure having a plurality of connection portions, the same transmittance-wavelength dependency can be obtained with respect to a plurality of emission-side plasmon waveguides 5. That is, the structure obtained in this case can function as an optical demultiplexer.

Next, a plasmon waveguide according to a fourth embodiment will be described. FIG. 18 is a view illustrating a plasmon waveguide according to the fourth embodiment.

The plasmon waveguide 1 of the fourth embodiment includes a cladding 2 made of metal and a dielectric core 3 and is provided with a first incident-side plasmon waveguide 41, a second incident-side plasmon waveguide 42, an emission-side plasmon waveguide 5, a first connection portion 61 connecting the first incident-side plasmon waveguide 41 and the emission-side plasmon waveguide 5, a second connection portion 62 connecting the second incident-side plasmon waveguide 42 and the emission-side plasmon waveguide 5, a first plasmon interference structure 71 protruding to the opposite side of the first incident-side plasmon waveguide 41 with respect to the first connection portion 61, a second plasmon interference structure 72 protruding to the opposite side of the second incident-side plasmon waveguide 42 with respect to the second connection portion 62, a third plasmon interference structure 73 protruding to the opposite side of the emission-side plasmon waveguide 5 with respect to the second connection portion 62, and a first joint 81 connecting the first connection portion 61 and second connection portion 62, thereby functioning as an optical wavelength multiplexer/demultiplexer.

According to the fourth embodiment, it is possible to provide a plasmon waveguide having a short element length in the incident-light traveling direction and a simple structure, capable of increasing the transmittance with a bent waveguide, having high wavelength selectivity, and having a function as an optical multiplexer.

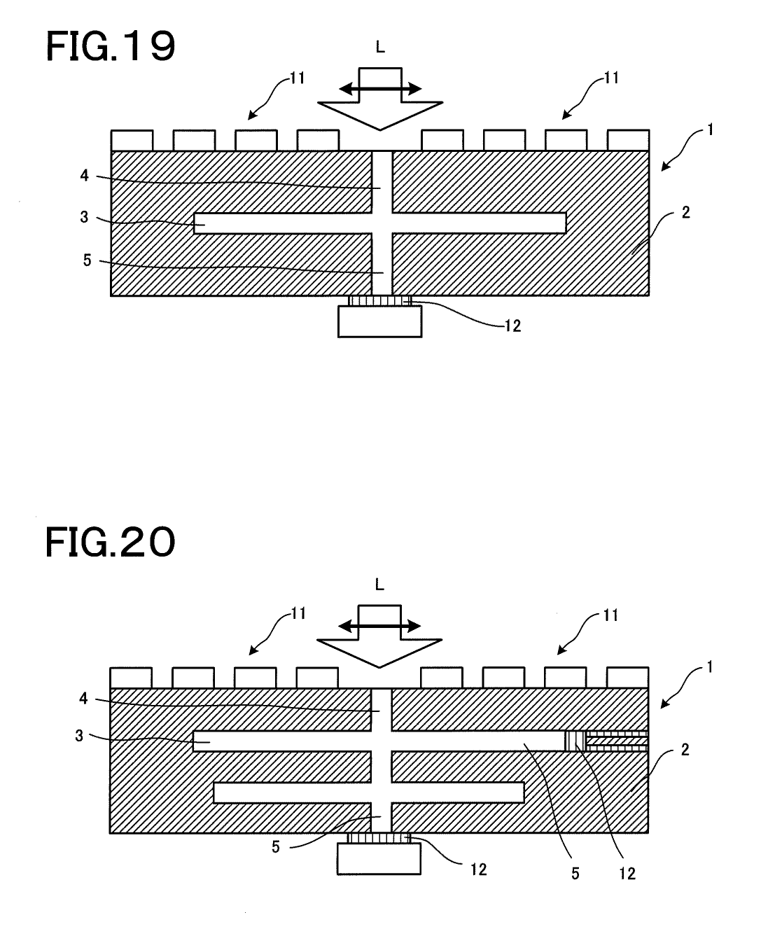

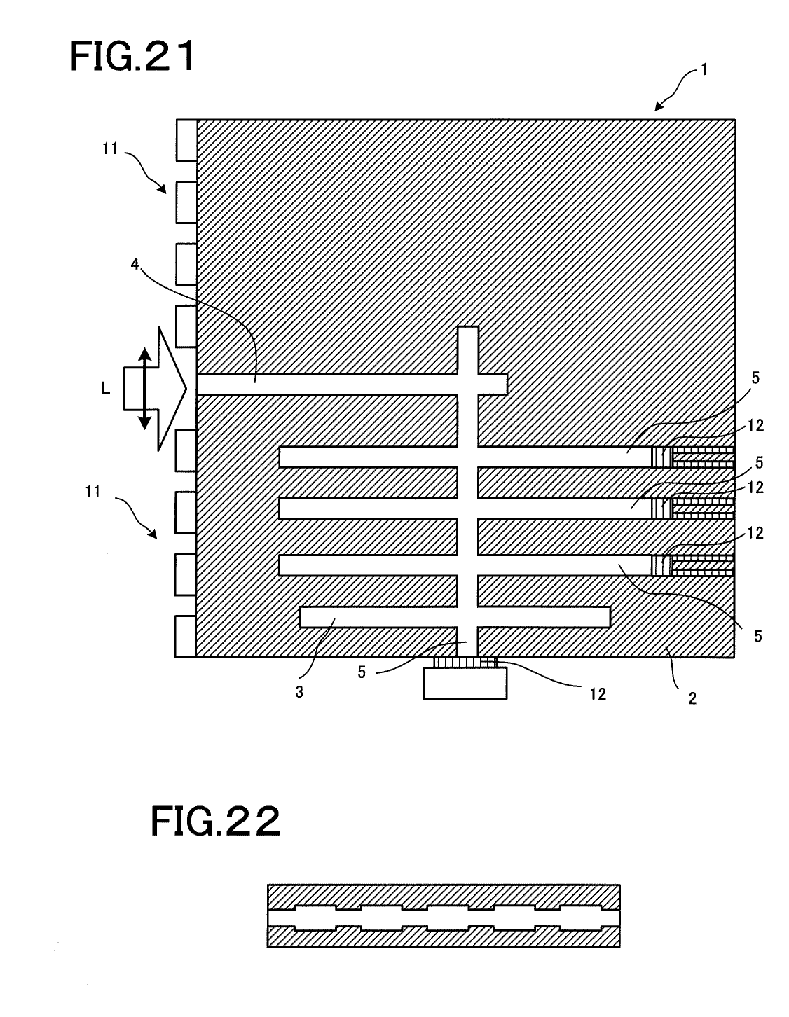

As applications of the plasmon waveguides 1 according to the first to third embodiments, structures as illustrated in FIGS. 19, 20, and 21 can be considered, in which a metal periodic structure called a surface plasmon antenna 11 is formed on the incident surface of the incident-side plasmon waveguide 4 and a photodiode 12 having a minute light receiving section is disposed at the end of the emission-side plasmon waveguide 5.

In the structure called the surface plasmon antenna 11, the periodic structure on the incident surface enhances the resonance of the surface plasmon to strengthen the light incident into a minute opening, resulting in the enhancement of the intensity of the light reaching the photodiode 12 in the minute opening, which allows highly sensitive light detection. Further, the photodiode 12 is minute, so that electric capacitance can be reduced to thereby realize high-speed response in an electronic circuit.

The surface plasmon antenna 11 can enhance the intensity of the light incident into the minute opening and its enhancement degree has a wavelength dependency. However, the wavelength range within which high enhancement degree can be obtained is comparatively wide. Thus, in the case where only one of optical signals having two close wavelengths needs to be detected, it is necessary to provide a wavelength filter or wavelength demultiplexer for controlling transmission of propagating light in front of the surface plasmon antenna 11. Adding the plasmon waveguide 1 having a wavelength filter function to the surface plasmon antenna 11 allows detection of light with an arbitrary spectrum. Thus, a small-sized high sensitivity/high-speed response light receiving element that can receive only light with an arbitrary spectrum can be achieved.

In a conventional technique, the number of the surface plasmon antennas corresponding to the number of wavelength to be measured have been prepared and arranged, resulting in a need for a large area to be used for the surface plasmon antennas (Patent Document 4).

Thus, by adopting a plasmon waveguide according to the above embodiments functioning as a wavelength demultiplexer, it is possible to perform wavelength filtering or optical wavelength demultiplexing with the short element length in the traveling direction of the light incident into the minute opening without using a conventional large-sized element, such as a wavelength filter or wavelength demultiplexer that handles propagating light, thus achieving a small-sized high sensitivity/high-speed response light receiving element that demultiplexes a given spectrum into a plurality of arbitrary spectrums in terms of wavelength inside a single surface plasmon antenna 11 and allows individual photodiodes 12 to receive the resultant spectrums.

In the above embodiments, the cladding 2 is used as the main body of the plasmon waveguide 1 and has a large thickness. However, it is only necessary for the cladding 2 to surround or sandwich the dielectric body 3. For example, a configuration may be adopted in which a film cladding 2 is used to surround or sandwich the dielectric body 3 and another material is provided outside the film cladding 2 as the main body of the plasmon waveguide 1. This configuration enables a reduction in cost.

The plasmon waveguide 1 according to the above embodiments has a rectangular dielectric core 3 in which the value obtained by multiplying the cross-sectional thickness of the dielectric core 3 by the refractive index of the dielectric core 3 is equal to or less than the half of the wavelength of light in a vacuum, that is, the following conditional expression (2) is satisfied:

t×n<0.5λ (2)

where t is the cross-sectional thickness of the dielectric core 3;

n is the refractive index of the dielectric core 3; and

λ is the wavelength of the light in a vacuum.

When the conditional expression (2) is satisfied, in the light propagation mode in the waveguide in the direction of the thickness t of the dielectric core 3, only the basic mode has a very low propagation loss as described in Patent Document 3, so that the basic mode becomes much dominant.

When the light path length in the thickness direction of the dielectric core is made larger than 0.5λ, the high order propagation mode in the direction of the thickness t of the dielectric core 3 starts to be established to make constructive interference of the emission light at the connection portion insufficient. Thus, a condition that the basic propagation mode in the thickness direction of the dielectric core becomes dominant is desired.

### INDUSTRIAL APPLICABILITY

According to the present invention, there can be provided a plasmon waveguide having a short element length in the incident-light traveling direction and a simple structure, and having high wavelength selectivity. Further, it is possible to increase the transmittance with a bent waveguide. Further, it is possible to make the plasmon waveguide function as an optical demultiplexer or multiplexer having high wavelength selectivity.

### EXPLANATION OF REFERENCE SYMBOLS

1: Plasmon waveguide

2: Cladding

3: Dielectric core

4: Incident-side plasmon waveguide

5: Emission-side plasmon waveguide

6: Connection portion

7: Plasmon interference structure

L: Light

1. A plasmon waveguide constituted by including a cladding comprised of metal and a dielectric core which is surrounded or sandwiched by the cladding and has at least one cross-section having a thickness equal to or less than the wavelength of the incident light, characterized by comprising:
an incident-side plasmon waveguide into which light is incident;
an emission-side plasmon waveguide from which the light is emitted;
a connection portion which connects the incident-side plasmon waveguide and the emission-side plasmon waveguide; and
a plasmon interference structure which extends from the connection portion in the direction intersecting the incident-side plasmon waveguide or the emission-side plasmon waveguide and has a terminal at which the light is reflected.

2. The plasmon waveguide according to claim 1, characterized in that
the plasmon waveguide has a plurality of the plasmon interference structures.

3. The plasmon waveguide according to claim 1 or claim 2, characterized in that
the incident-side plasmon waveguide and emission-side plasmon waveguide extend in different directions.

4. The plasmon waveguide according to claim 1 or 2, characterized in that
the plasmon waveguide has a plurality of the incident-side plasmon waveguides.

5. The plasmon waveguide according to claim 1 or 2, characterized in that
the plasmon waveguide has a plurality of the emission-side plasmon waveguides.

6. The plasmon waveguide according to claim 1 or 2, characterized in that
the following conditional expression (1) is satisfied:
w×n<1.75λ (1)
where w is the length of the cross section of the dielectric core extending in the perpendicular direction to the thickness direction;
n is the refractive index of the dielectric core; and
λ is the wavelength of the light in a vacuum.

7. The plasmon waveguide according to claim 1 or 2, characterized in that
the following conditional expression (2) is satisfied:
t×n<0.5λ (2)
where t is the cross-sectional thickness of the dielectric core;
n is the refractive index of the dielectric core; and
λ is the wavelength of the light in a vacuum.

8. The plasmon waveguide according to claim 1 or 2, characterized in that
the length of the plasmon interference structure is determined such that light having a wavelength of 826.6 nm exhibits higher transmittance than light having a wavelength of 800 nm.

9. The plasmon waveguide according to claim 1 or 2, characterized in that
the cladding is formed of gold.

10. The plasmon waveguide according to claim 1 or 2, characterized in that
the dielectric core is formed of silicon oxide.

11. An optical element constituted by using the plasmon waveguide according to claim 1 or 2.
